(19) United States
(12) Patent Application Publication
(10) Pub. No.: US 2026/0017076 A1
(43) Pub. Date: Jan. 15, 2026

(54) SYSTEMS AND METHODS FOR CONTEXT-AWARE ASSISTANCE VIA OVERLAY-BASED CONTENT CAPTURE

(71) Applicant: Celligence International LLC, Guaynabo, PR (US)

(72) Inventors: Pavan AGARWAL, Dorado, PR (US); Gabriel Albors SANCHEZ, San Juan, PR (US); Jonathan Ortiz RIVERA, San Juan, PR (US)

(73) Assignee: Celligence International LLC, Guaynabo, PR (US)

(21) Appl. No.: 19/334,922

(22) Filed: Sep. 21, 2025

Related U.S. Application Data
(63) Continuation-in-part of application No. 19/229,943, filed on Jun. 5, 2025.
Application No. 19/229,943 is a continuation-in-part of application No. 18/135,703, filed on Apr. 17, 2023, now Pat. No. 12,393,433.
(60) Provisional application No. 63/332,205, filed on Apr. 18, 2022.

(51) Int. Cl. G06F 9/451; G06F 21/62; G06V 30/414

(52) U.S. Cl. CPC G06F 9/453; G06F 21/629; G06V 30/414

(57) ABSTRACT

Systems and methods are provided for delivering context-aware assistance through an overlay interface. An overlay rendered on a user device captures content of a host application underlying the overlay via a scan-snap process. Captured content is filtered by privacy controls, transmitted securely to a server, analyzed to determine contextual meaning, and used to generate a response displayed in the overlay. In certain embodiments, capture includes document object model (DOM) snapshots, pixel-buffer screenshots, or fusion of DOM and bitmap data, optionally preceded by lightweight on-device optical character recognition. Mobile embodiments invoke the overlay through gesture inputs, while desktop embodiments employ a clipping interface with live preview of the selected capture region. Enterprise-oriented embodiments enforce policy restrictions, mask sensitive fields, and maintain audit logs, while multi-device embodiments synchronize responses across mobile and desktop sessions. The system thereby enables accurate, privacy-preserving contextual assistance without requiring remote access or manual user explanation.

### RELATED APPLICATIONS

This application a continuation-in-part of U.S. patent application Ser. No. 19/229,943, filed on Jun. 5, 2025, which is a continuation-in-part of U.S. patent application Ser. No. 18/135,703, filed on Apr. 17, 2023, which claims the benefit of U.S. Provisional Application No. 63/332,205 filed on Apr. 18, 2022, the contents of which are incorporated herein by reference in its entirety.

### FIELD OF INVENTION

The present disclosure relates generally to computer-implemented user assistance systems, and more specifically to systems and methods for providing context-aware support through an overlay interface that captures and analyzes underlying content.

### BACKGROUND

Traditional web-based customer service chat interfaces require a user to open a separate chat window and manually explain an issue. This creates inefficiency, user frustration, and ambiguity, as the system lacks awareness of the precise webpage content causing confusion. Some users attempt to share screenshots or grant remote access, which introduces privacy, security, and usability concerns.

Accordingly, there is a need for an integrated chat bot interface that allows the system to see what the user sees on the host website, analyze that context directly, and provide targeted responses without requiring manual explanation or remote control.

### SUMMARY

The present disclosure relates to computer-implemented systems and methods for providing context-aware assistance through an overlay interface. In one embodiment, a method includes rendering an overlay on a user device, capturing underlying content of a host application using a scan-snap process, applying redaction or privacy filters, transmitting filtered content securely to a server, analyzing the content to determine user context, and generating a contextual response for display within the overlay. Dependent method embodiments provide refinements including DOM and pixel buffer capture, lightweight on-device OCR pre-processing, viewport stability detection, region inference to exclude overlay chrome, and invocation of external APIs for OCR and domain-specific data. Additional embodiments cover mobile implementations where the overlay is invoked through gesture input, and desktop implementations where a clipping interface presents a live preview of a user-defined capture region. Enterprise-oriented embodiments extend the workflow to include policy enforcement, masking of sensitive data, and audit logging, while multi-device embodiments synchronize responses across mobile and desktop sessions. Parallel system claims recite a user device with overlay, capture, privacy, and transmission modules in communication with a server comprising content analysis and response generation modules, with dependent claims covering the same refinements. Collectively, the claims secure protection for the full workflow of capturing, filtering, transmitting, analyzing, and responding to user context across mobile, desktop, and enterprise environments.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIGS. 1A-1C are block diagrams illustrating exemplary system architectures, including a server-based overlay assistance system (FIG. 1A), a mobile device embodiment (FIG. 1B), and a desktop device embodiment (FIG. 1C), according to an implementation of the disclosure.

FIGS. 2A-2D are user interface diagrams illustrating stages of interaction with an overlay assistant, including invocation, semi-transparent display, scan snap capture, and contextual response presentation, according to an implementation of the disclosure.

FIG. 3 is flowchart illustrating an example method for providing context-aware assistance using overlay-based content capture, according to an implementation of the disclosure.

FIG. 4 is flowchart illustrating an example mobile capture pipeline for overlay-based content capture and response generation, according to an implementation of the disclosure.

FIG. 5 is a flowchart illustrating an example desktop capture pipeline including clipping interface and live preview functions, according to an implementation of the disclosure.

FIG. 6 is a flow diagram illustrating multi-device session continuity in which a scan snap is captured on a mobile device and a contextual response is synchronized to a desktop device, according to an implementation of the disclosure.

FIG. 7 is a flow diagram illustrating enterprise policy enforcement during overlay-based content capture, including redaction, filtering, and audit logging, according to an implementation of the disclosure.

FIG. 8 illustrates an example computing system that may be used in implementing various features of embodiments of the disclosed technology.

Described herein are systems and methods for providing overlay-based contextual assistance within a conversational framework. During a session, the system enables a user to invoke an overlay on a first device, such as a mobile phone, and capture a portion of the underlying host application through a scan snap operation. The captured content is encrypted and transmitted to a conversational application server, where content analysis and policy modules classify the capture (e.g., text, images, or structured DOM elements) and apply retention, masking, or expiration rules. Entries may be persisted in a centralized context and capture data store 108, where they are indexed for session continuity, multi-device synchronization, or audit logging. Notifications may be propagated to a user's other devices, such as a desktop computer, where a synchronized response is surfaced in the overlay interface through a response facilitator. In some embodiments, enterprise-controlled entries require policy validation or user authentication before release. This architecture improves usability and workflow efficiency by eliminating error-prone manual description of problems, while providing technical advantages such as accurate alignment of captured regions, automated redaction of sensitive information, session continuity across devices, and centralized governance over capture and response policies. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

In a present embodiment, an overlay-based capture and assistance system enables a user to initiate a scan snap on one device and seamlessly receive a contextual response on another without requiring manual explanation or transfer. When a user invokes the overlay on a mobile device and captures underlying host content, the system detects the capture event, classifies the captured data, and securely synchronizes it through a server-based framework. Captured payloads are persisted in a centralized session-scoped data store, which maintains synchronized entries along with associated metadata such as content type, originating device, capture time, and applicable retention or masking policies. Upon switching to a desktop environment, the system surfaces the synchronized capture as part of the ongoing session, presenting both the captured content and the contextual AI response within the overlay interface. This provides a fluid and intelligent mechanism for extending assistance across devices while preserving context, privacy, and security.

As used herein, the term “web-chat scan snap” refers to a process of automated content capture beneath a semi-transparent overlay interface associated with a conversational assistant. In this process, the overlay is presented on top of a host webpage or application, and upon a user action (e.g., gesture, click, or viewport stability event) the system identifies and captures the portion of the host content underlying the overlay. The capture may include a pixel-buffer screenshot, a document object model (DOM) snapshot, or a fused representation thereof. The captured content is then processed by privacy filtering, transmitted securely, and analyzed to generate a context-aware response.

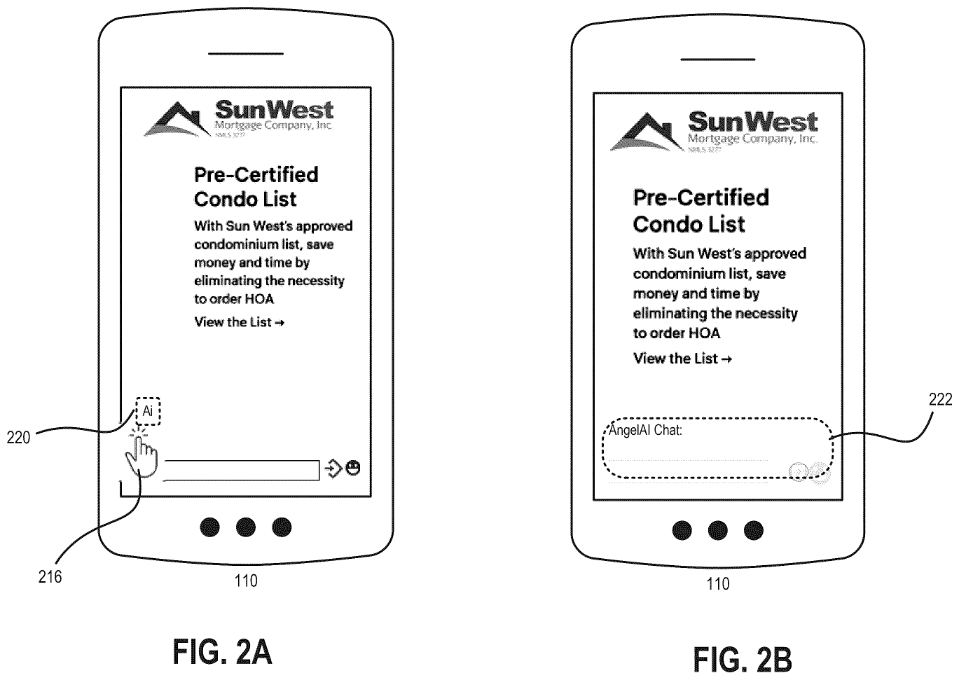

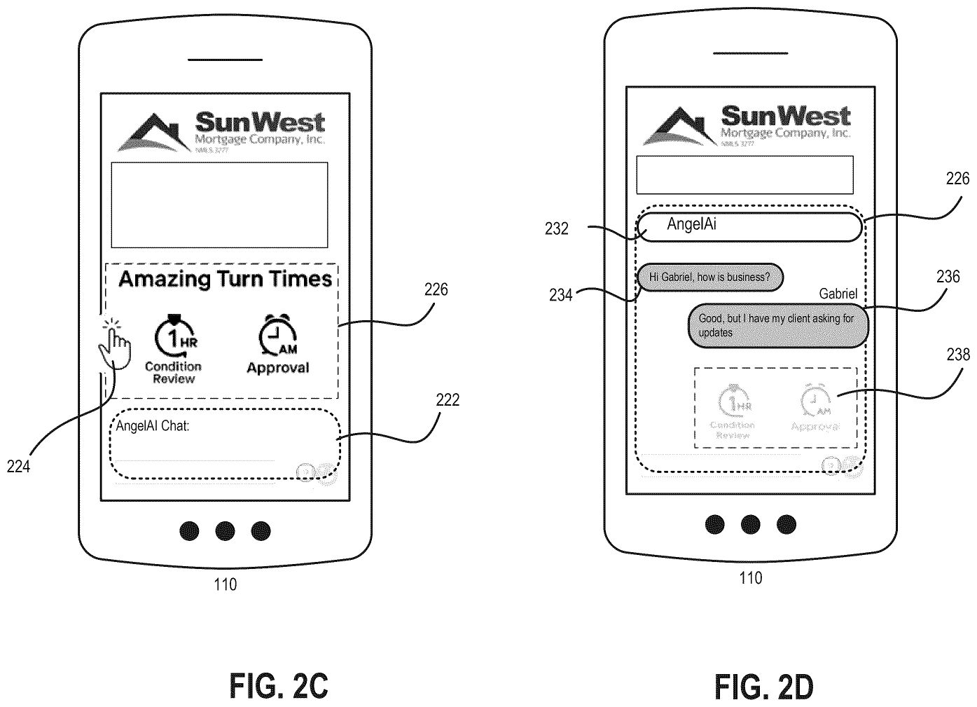

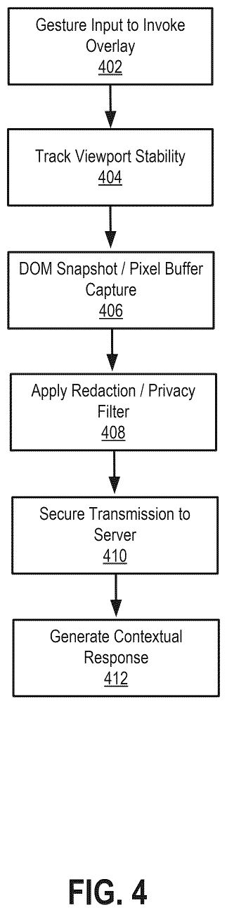

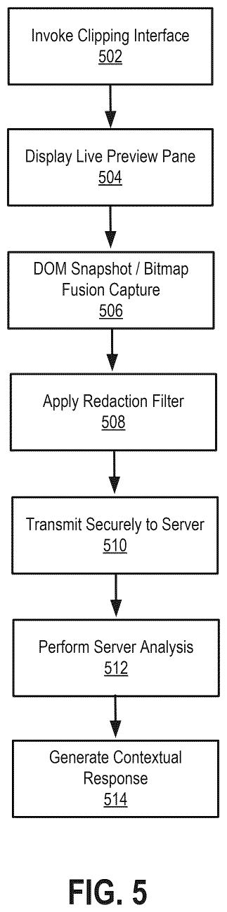

While this functionality may be referred to in some implementations as a “Web-Chat Scan Snap” feature, the disclosure is not limited to web environments; the same process may be implemented in native mobile or desktop applications, or any system employing an overlay interface for contextual assistance. As illustrated in FIG. 2C, a scan snap event highlights and captures a region of host content beneath the overlay. In FIG. 4, the mobile capture pipeline depicts gesture-based initiation, viewport tracking, DOM or pixel capture, redaction, and secure transmission as part of a scan snap operation. In FIG. 5, the desktop pipeline demonstrates scan snap capture through a clipping interface with live preview and DOM+bitmap fusion. Collectively, these figures illustrate exemplary implementations of the web-chat scan snap process across different devices and contexts, confirming that the definition encompasses both web-based and native overlay environments.

### Conventional System Limitations

Conventional web-based customer service systems typically rely on chat widgets that operate in isolated pop-up windows. These systems require a user to manually describe the source of confusion by typing text into a chat box. When a user attempts to provide visual context, conventional systems depend on uploading static screenshots or granting full remote access to the device. Such approaches introduce friction, delay, and security concerns. Manual description is often inaccurate or incomplete, resulting in misinterpretation of the user's problem. Uploading screenshots is cumbersome and breaks conversational flow. Granting remote access exposes the user to privacy risks and potential unintended modifications of the device environment. In addition, conventional chat systems lack continuity across devices and rarely include enterprise policy enforcement, limiting their deployment in regulated industries.

### Technical Improvements of the Present Disclosure

The systems and methods described herein provide significant technical improvements over conventional approaches. By implementing an overlay-based capture mechanism (web-chat scan snap), the system enables automated identification and acquisition of the precise content underlying a conversational interface, without requiring manual uploads or remote access. The use of semi-transparent overlays, DOM snapshotting, pixel-buffer grabs, lightweight OCR prepasses, and region-inference techniques produces higher fidelity captures aligned to the user's actual context. Integrated privacy control and enterprise policy modules allow sensitive data to be redacted or blocked before transmission, ensuring compliance with security and governance requirements. The architecture further supports cross-device synchronization, enabling a capture on one device (e.g., mobile) to produce a contextual response seamlessly surfaced on another device (e.g., desktop). These improvements reduce user burden, accelerate problem resolution, preserve privacy, and expand applicability to enterprise workflows, thereby providing concrete technical advantages over conventional customer service chat systems.

The following figures provide a high-level overview of the system architecture, illustrating key modules and data flows between user devices and the server.

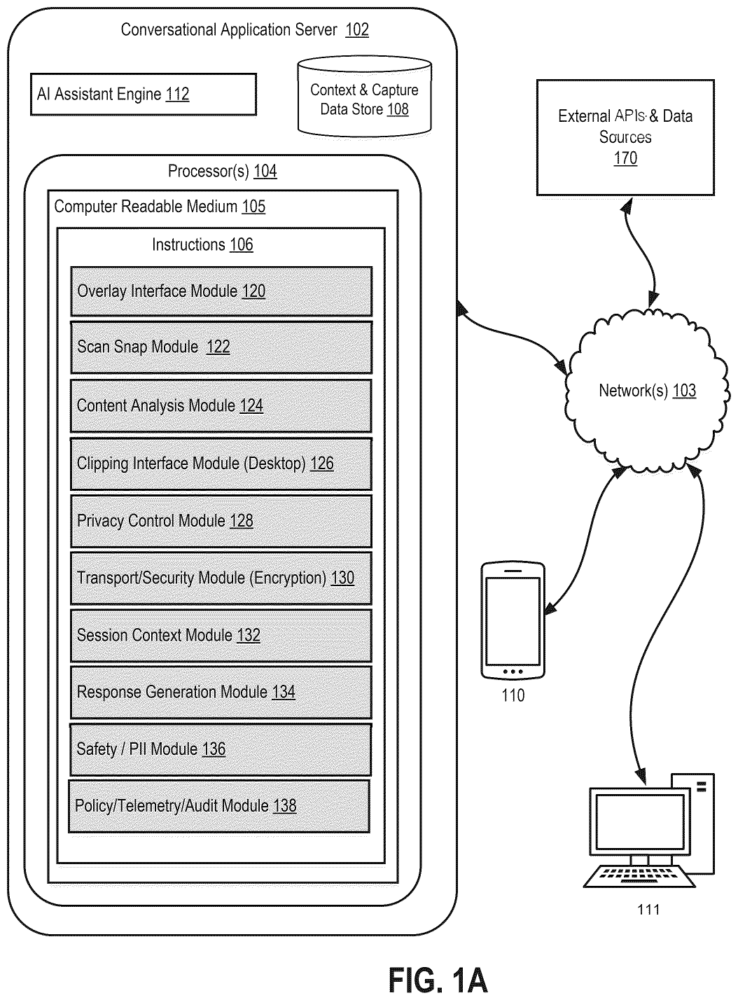

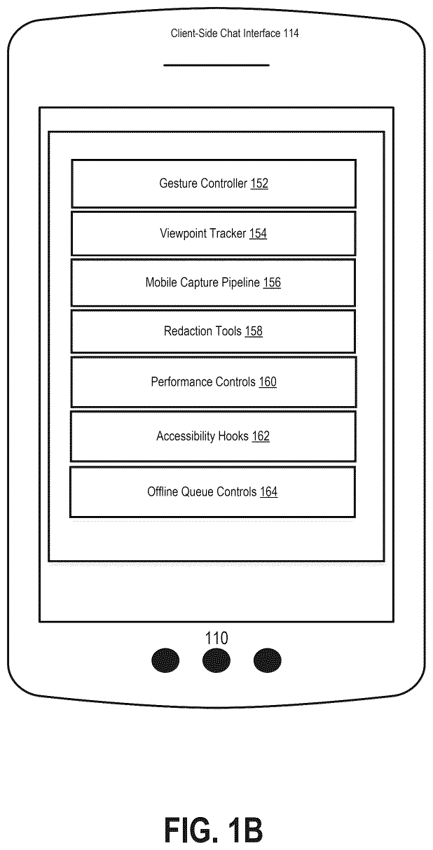

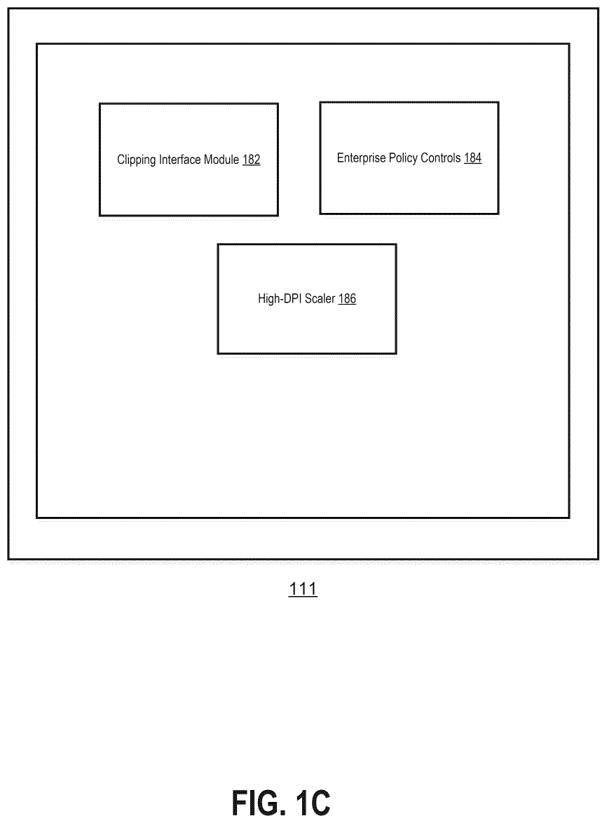

FIG. 1 illustrates an exemplary architecture for providing context-aware assistance through an overlay-based content capture system. As shown, a conversational application server 102 is communicatively coupled to one or more user devices, such as a mobile device 110 and a desktop device 111, via one or more networks 103. The server 102 may also interface with external APIs and data sources 170 to obtain third-party services, enrichments, or supplemental model data that enhance analysis and response generation.

The conversational application server 102 includes an AI assistant engine 112, which may comprise a conversational AI framework configured to interact with end users through natural language input and output. The server further includes a context and capture data store 108, which maintains records of captured overlay content, session state information, and metadata derived from analysis operations. The data store 108 may be implemented using relational databases, non-relational stores, or distributed storage infrastructures, depending on scalability requirements.

The server 102 includes one or more processors 104 coupled to a computer-readable medium 105 storing instructions 106 that are executable to implement the functional modules of the system. These modules include an overlay interface module 120 that controls presentation of a semi-transparent or split-screen overlay on the user device, enabling simultaneous access to both the host application and the AI assistant. The scan snap module 122 operates to capture underlying webpage or application content located beneath the overlay at the moment of invocation. Captures may be triggered by gestures, user selections, viewport stability, or explicit commands. The content analysis module 124 receives captured data and applies one or more analytic processes-such as optical character recognition (OCR), DOM parsing, and natural language processing-to determine contextual meaning and user intent.

In desktop embodiments, a clipping interface module 126 may be invoked to allow the user to manually select a region of the host application for capture. The selected region may be displayed in a live preview within the overlay before transmission to ensure transparency and user control. Captured content is subject to processing by a privacy control module 128, which applies filtering, redaction, and consent policies to remove sensitive or unauthorized data prior to transmission. Transmission itself is performed under the supervision of a transport and security module 130, which may apply encryption, authentication, and other security measures to ensure integrity and confidentiality of the data in transit.

A session context module 132 maintains state across multiple interactions, storing metadata such as timestamps, URLs, user identifiers, and the sequence of captured events. This ensures continuity across a session and allows the AI assistant engine 112 to respond with awareness of prior context. A response generation module 134 leverages outputs from the content analysis module 124, the session context module 132, and external APIs 170 to generate a context-aware response. The response is delivered back to the overlay interface module 120 and presented in the user's conversational window.

To further ensure security and compliance, the system implements a safety and PII module 136 configured to detect personally identifiable information in both captured data and generated responses. The safety and PII module 136 may remove or mask sensitive content before it is stored, transmitted, or displayed. In enterprise environments, a policy, telemetry, and audit module 138 may be used to enforce organizational capture policies, maintain audit logs of capture and response events, and provide telemetry for system performance and compliance reporting.

Through this arrangement of module, the architecture of FIG. 1 enables mobile and desktop devices to engage in context-aware conversations with an AI assistant without requiring remote desktop access or burdensome manual explanation. Instead, relevant portions of the host interface are captured, analyzed, and used to generate intelligent, targeted responses while preserving user privacy and enabling enterprise oversight.

In certain embodiments, the mobile device 110 executes client-side components that interact with the modules of server 102 to facilitate capture and assistance operations optimized for smaller screens. The overlay interface on the mobile device may be invoked through gesture input, such as a swipe, pull-up action, or long-press on a screen element, which triggers the overlay interface module 120. The mobile overlay may be rendered in a semi-transparent state so that a user can continue scrolling or navigating the underlying application while maintaining visibility of the assistant. When a scan snap capture is initiated, the mobile device 110 may locally buffer the captured content and perform lightweight preprocessing such as scaling or preliminary optical character recognition to extract salient features before transmission. The mobile device may also integrate redaction tools allowing a user to tap or mask portions of the capture prior to submission, thereby increasing user confidence and maintaining privacy. Processed content is then transmitted through the transport and security module 130 to server 102 for deeper analysis and response generation. The integration of gesture-based invocation, lightweight local preprocessing, and interactive redaction enables mobile device 110 to provide a streamlined, user-friendly embodiment of the overlay-based contextual assistance system.

In other embodiments, the desktop device 111 supports additional client-side functionality that leverages larger screen real estate and peripheral input devices. The overlay interface may be invoked through mouse or keyboard shortcuts, such as a click on an icon, a key combination, or a voice command. In desktop mode, the clipping interface module 126 is particularly advantageous, allowing the user to define a rectangular region of the underlying application window using a click-and-drag action. The defined region is displayed in a live preview pane within the overlay interface prior to submission, providing assurance of exactly what will be transmitted to the server 102. The desktop device 111 may also support multi-monitor awareness, ensuring that capture operations are constrained to the host application window even when multiple displays are active. Captured content can include both pixel-level screenshots and structured document object model (DOM) elements, which may be fused together before transmission for more accurate downstream processing by the content analysis module 124. As with the mobile device, the desktop device applies privacy controls and encryption before transmitting captured data, but further offers enterprise policy features such as domain-level allowlists or restrictions on capture scope. These enhancements make the desktop device 111 embodiment particularly suitable for enterprise deployments and professional workflows requiring fine-grained control, compliance, and visibility.

The system may further interface with external APIs and data sources 170 to augment the functionality of the AI assistant engine 112 and its supporting modules. In some embodiments, the content analysis module 124 invokes external services such as optical character recognition engines, domain-specific knowledge bases, or third-party data enrichment platforms to enhance the accuracy and scope of contextual understanding. For example, when a captured region includes highly stylized text or images, the system may call an external OCR API for improved character recognition. Similarly, domain-specific APIs—such as real estate listing databases, financial service endpoints, or healthcare information repositories—may be queried to provide authoritative answers that the AI assistant engine 112 can incorporate into its response. The external APIs 170 may also support integration with communication services, workflow systems, or enterprise compliance platforms, enabling the assistant to execute actions beyond simple responses, such as initiating a transaction, updating a customer record, or logging an audit event. Data exchange with external APIs 170 is managed through the transport and security module 130 to ensure encryption, authentication, and policy compliance. In this manner, the system remains extensible, adaptable to a wide range of use cases, and able to leverage specialized data sources while maintaining secure and controlled communication channels.

The server 102 includes one or more processors 104 configured to execute computer-readable instructions 106 stored on a non-transitory medium. The instructions 106 implement a conversational application 112 and associated functional modules. As shown, the server 102 is operatively connected to multiple datastores, including a user memory data store 190 for encrypted clipboard entries and associated metadata; a device registry data store 191 for managing trusted devices associated with user accounts; a secrets vault 192 for cryptographic keys and policy material; a content feature index 193 for non-sensitive derived features (e.g., content type or hash values); and a telemetry data store 194 for metrics, logging, and compliance reporting. The functional modules are organized into groups including AI/ML logic components 112, 114, 116, 118; orchestration and session management components 120, 122, 124; governance and security components 130, 131, 132, 134, 136, 138; and defensive mechanisms 142.

Hardware processor 104 may be one or more central processing units (CPUs), semiconductor-based microprocessors, and/or other hardware devices suitable for retrieval and execution of instructions stored in computer readable medium 105. Processor 104 may fetch, decode, and execute instructions 106, to control processes or operations for automatically categorizing tasks and assigning color. As an alternative or in addition to retrieving and executing instructions, hardware processor 104 may include one or more electronic circuits that include electronic components for performing the functionality of one or more instructions, such as a field programmable gate array (FPGA), application specific integrated circuit (ASIC), or other electronic circuits.

A computer readable storage medium, such as machine-readable storage medium 105 may be any electronic, magnetic, optical, or other physical storage device that contains or stores executable instructions. Thus, computer readable storage medium 105 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 105 may be a non-transitory storage medium, where the term “non-transitory” does not encompass transitory propagating signals. As described in detail below, machine-readable storage medium 105 may be encoded with executable instructions, for example, instructions 106.

FIG. 1B depicts an embodiment of the mobile device 110 implementing a client-side chat interface 114 that cooperates with the server-side modules of FIG. 1. The client-side chat interface 114 may expose a gesture controller 152 that receives user inputs—such as a pull-up gesture, swipe, long-press, or tap-and-hold—to invoke the overlay interface or to initiate a capture event. A viewport (viewpoint) tracker 154 monitors scroll position and viewport stability; for example, the tracker 154 may detect that the user has ceased scrolling for a threshold interval and surface a capture affordance or automatically trigger a scan snap. A mobile capture pipeline 156 acquires beneath-overlay content from the host application, which may include one or more of a raster screenshot, a DOM fragment, and a set of accessibility semantics, and may optionally perform on-device preprocessing such as down-scaling, compression, or a lightweight OCR pass to extract token hints prior to upload. The interface 114 further includes redaction tools 158 enabling the user to mask, blur, or omit selected regions before any transmission occurs, thereby enforcing user consent and minimizing exposure of sensitive information. Performance controls 160 adjust overlay opacity, frame-rate, and GPU composition settings to maintain interactive responsiveness on resource-constrained devices. Accessibility hooks 162 register labels and roles for capture buttons and previews so that assistive technologies (e.g., VoiceOver®/TalkBack®) can announce capture state and allow keyboard-free operation.

In some embodiments, the client integrates offline queue controls 164, which buffer capture artifacts and associated metadata in a secure local store and release them under policy—e.g., upon Wi-Fi availability, device charging, or successful user re-authentication—using exponential backoff and integrity checks. The foregoing client-side components interoperate with the privacy control module 128 and transport/security module 130 to apply redaction and encryption prior to transmission, and with the content analysis module 124 and response generation module 134 to obtain context-aware guidance rendered back within the client-side chat interface 114.

In some embodiments, the mobile capture pipeline 156 supports multiple acquisition modes to ensure fidelity across device types and rendering engines. For example, when the chat overlay is presented within a WKWebView or Chromium-based renderer, the pipeline may include a DOM snapshotter that exports the underlying document object model, including node structure, element attributes, and style information. In alternative or complementary modes, the pipeline may access a pixel buffer grab of the rendered screen region, producing a bitmap suitable for image-based analysis. The captured DOM and pixel data may be fused to improve alignment between visual layout and semantic content.

To accelerate response time and reduce server load, the pipeline may also perform a lightweight OCR prepass on the device. This prepass extracts candidate tokens, entity hints, or text bounding boxes from the captured image, which can be transmitted alongside the raw capture as supplemental metadata. Such preprocessing enables the content analysis module 124 to quickly filter, classify, or route requests without requiring full-scale OCR on every transaction.

In certain implementations, the system further employs a region inference mechanism to determine what content lies “under” the overlay at the time of capture. Region inference may use geometric heuristics to ensure that captured bounds align with valid screen areas and exclude overlay chrome. For example, the module may detect safe bounds around rounded overlay corners, adjust for scrolling offsets, and constrain captures to the visible viewport. This prevents the inadvertent inclusion of blank space, cut-off text, or assistant UI elements in the scan snap, thereby improving the accuracy of subsequent analysis.

FIG. 1C illustrates an embodiment of the desktop device 111 providing client-side components tailored to larger displays and pointer/keyboard input. A clipping interface module 182 enables a user to define a capture region using a click-and-drag rectangle, keyboard shortcuts, or a context menu. The selected region may be presented in a live, in-overlay preview to confirm the exact pixels and/or DOM elements to be transmitted, and the preview may support re-sizing, nudging, and constraint to the active application window or tab. An enterprise policy controls 184 component enforces organizational restrictions—such as domain allow-/deny-lists, prohibition of full-screen captures, maximum capture area, automatic redaction of specified UI chrome (e.g., URL bar), and retention windows for any locally cached artifacts—with audit signals emitted to the policy/telemetry/audit module 138. A high-DPI scaler 186 normalizes captures from high-density displays (e.g., 2×/3× device pixel ratio) to server-preferred dimensions and color space while preserving legibility for downstream OCR and layout analysis; in some cases, the scaler 186 fuses a bitmap capture with an element tree exported from the host renderer to improve alignment during analysis by module 124. The desktop components interoperate with privacy control module 128 and transport/security module 130 to enforce consent and encryption, and with response generation module 134 to render targeted assistance within the overlay on device 111; multi-monitor configurations may be supported by constraining the clipping interface 182 to the active window and by recording monitor geometry in the session context module 132 for reproducibility.

In some embodiments, the clipping interface module 182 renders a live preview pane inside the overlay interface on desktop device 111. The live preview pane displays in real time the exact region selected for capture, ensuring that a user has full visibility into what will be transmitted to the server 102. The preview may update dynamically as the user resizes or repositions the selection rectangle, and may include visual cues such as bounding boxes or pixel counts. This feature improves transparency, prevents inadvertent sharing of sensitive regions, and enhances trust in the capture workflow.

The desktop embodiment may also implement multi-monitor awareness to address modern computing environments where users often operate multiple displays. The clipping interface module 182 can detect the geometry of active displays and constrain capture operations to the current application window or selected monitor. This ensures that capture operations do not inadvertently include off-screen buffers, background applications, or windows positioned outside the active viewport, thereby preserving data integrity and limiting the scope of captured content.

In addition, the system may employ DOM plus bitmap fusion to improve downstream analysis. In this mode, the clipping interface module 182 exports both a structural representation of the page or application (such as an HTML DOM tree or application UI element tree) and a corresponding bitmap image of the rendered pixels. The exported DOM provides semantic context such as element types and text values, while the bitmap preserves exact visual layout. The fusion of DOM and bitmap data enables the content analysis module 124 to perform more accurate OCR, element mapping, and contextual classification.

The desktop device 111 may further provide keyboard shortcut integration, allowing users to trigger a scan snap operation quickly without navigating menus. For example, a user may press “Ctrl+Shift+S” or “Cmd+Shift+S” to initiate a capture, at which point the clipping interface module 182 highlights the region selection tool and surfaces the live preview pane. Keyboard integration improves efficiency for advanced users and aligns the capture workflow with established productivity shortcuts.

FIG. 2A illustrates an initial stage of interaction on a mobile device 110, in which a user invokes the overlay interface through a gesture input. As shown, the user performs a swipe or pull-up action 216 detected by the gesture controller 152. The gesture controller 152 interprets the motion and activates the overlay interface while maintaining visibility of the underlying webpage or application content. This invocation is lightweight and immediate, allowing the assistant to appear without interrupting the user's navigation flow.

FIG. 2B shows the overlay interface 222 rendered in a semi-transparent state over the host application content. The overlay behavior is managed by the viewport tracker 154 in combination with the performance controls 160, which together ensure that the user can scroll the underlying application while the overlay dynamically adjusts opacity and placement. This transparency feature allows the user to navigate, locate areas of confusion, and maintain situational awareness of the host application while still engaging with the assistant.

FIG. 2C depicts a capture initiation event in which the user triggers a scan snap action 224 to capture the portion of the host application visible beneath the overlay. The capture operation is executed by the mobile capture pipeline 156, which may include both a DOM snapshotter and pixel buffer grab. Before transmission, the captured content is passed through the redaction tools 158, which enable masking or omission of sensitive information, and the offline queue controls 164, which buffer the content if immediate transmission is not possible. This step ensures that the assistant receives precise contextual input while preserving privacy and data integrity.

FIG. 2D illustrates the presentation of a contextual response within the overlay interface following content capture and analysis. The captured region 236, processed via the pipeline of module 156 and filtered by modules 158 and 160, is transmitted to the server 102 for analysis. The AI assistant (shown here as AngelAI 232 for illustrative purposes) generates a targeted response 234 based on the captured region and session context. The response is rendered back to the mobile client and surfaced through the accessibility hooks 162 and overlay interface, ensuring both clarity and usability across devices. The captured content may be displayed as a thumbnail 236 embedded within the chat stream to visually ground the response. Through this arrangement, the user can correlate the assistant's guidance with the exact area of the host application that triggered the question, leading to more efficient and accurate support interactions.

In desktop embodiments, the interaction sequence follows a similar flow but incorporates features specific to larger displays and peripheral input devices. A user may first invoke the overlay interface through a keyboard shortcut or menu selection, which activates the clipping interface module 182. The clipping interface module allows the user to define a capture region by dragging a cursor across the display, after which a live preview pane is presented within the overlay to show the exact portion of the host application that will be captured. This preview provides transparency and enables adjustments before proceeding.

Once a region is confirmed, the system acquires both a document object model (DOM) snapshot and a bitmap image of the defined area. These are fused together using the capabilities of the clipping interface module 182 and the high-DPI scaler 186, which ensures that high-density displays are normalized to server-preferred resolutions while preserving readability for optical character recognition. This DOM-plus-bitmap fusion approach provides both semantic detail and visual fidelity, resulting in more accurate contextual analysis.

The captured content is then filtered according to enterprise policy controls 184, which may enforce domain-level restrictions, mask sensitive fields, or block capture of unauthorized application windows. Such policy enforcement ensures that desktop implementations are suitable for enterprise use cases requiring auditability and compliance. After filtering, the content is encrypted and transmitted securely to the server for processing. The server then performs analysis and returns a contextual response, which is displayed in the overlay window of the desktop device.

Through this sequence of operations, the desktop embodiment provides fine-grained control and transparency over the capture process, ensures compliance with enterprise policies, and maintains high-fidelity data capture across multi-monitor and high-resolution environments. These enhancements make the desktop configuration particularly suited to professional and regulated industries where precision, compliance, and trust are paramount.

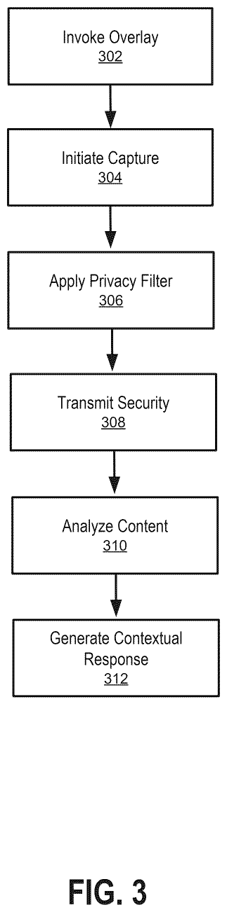

FIG. 3 illustrates an exemplary method for providing context-aware assistance using an overlay-based content capture system. The process begins when the user invokes the overlay (step 302), such as through a gesture on a mobile device or a keyboard shortcut on a desktop system. Once the overlay interface is active, the user or system initiates a capture event (step 304), referred to herein as a “scan snap,” which identifies and collects the portion of the host application or webpage underlying the overlay. Before any data is transmitted, the system applies a privacy filter (step 306) to redact sensitive regions, enforce policy restrictions, or remove personally identifiable information. Following redaction, the captured content is transmitted securely (step 308) to a remote server using encryption and authenticated transport protocols. At the server side, the system analyzes the captured content (step 310), for example by applying optical character recognition, document object model parsing, or natural language classification. Based on this analysis, the AI assistant engine generates a contextual response (step 312) that is returned to the user and displayed in the overlay interface. This method enables efficient and privacy-preserving assistance by ensuring that the AI assistant responds to the precise context of the user's confusion, without requiring lengthy manual explanation or invasive remote access.

FIG. 4 illustrates an exemplary mobile capture pipeline process for providing context-aware assistance via overlay-based content capture. The method begins when a user provides a gesture input to invoke the overlay (step 402), such as a swipe, pull-up, or long-press action on the mobile device 110. Once the overlay interface is active, the system proceeds to track viewport stability (step 404) by monitoring scrolling and pause events to determine when the underlying screen content is suitable for capture. At the appropriate moment, the mobile client performs a DOM snapshot or pixel buffer capture (step 406), acquiring either a structured representation of the underlying application content or a bitmap of the rendered screen region, or both in combination. Before transmission, the system applies redaction and privacy filtering (step 408), which may include user-directed masking, automatic detection of sensitive fields, or enterprise policy-based exclusions. The filtered content is then subjected to secure transmission to the server (step 410), with encryption and authentication applied by the transport/security module 130. Finally, the server performs content analysis and the AI assistant engine 112 generates a contextual response (step 412), which is delivered back to the mobile overlay for immediate user assistance. Through this process, the mobile pipeline enables fast, privacy-preserving contextual support without requiring users to manually describe their issues or expose their device to remote access.

FIG. 5 illustrates an exemplary desktop capture pipeline process for providing context-aware assistance. The method begins when a user invokes the clipping interface (step 502), for example by clicking a capture icon, selecting a menu option, or pressing a keyboard shortcut such as “Ctrl+Shift+S” or “Cmd+Shift+S.” Once activated, the system surfaces a capture tool that allows the user to define a rectangular region of the host application window. As the region is adjusted, the system displays a live preview pane (step 504) within the overlay interface, showing in real time the exact portion of the screen that will be transmitted. This preview provides transparency and allows the user to confirm or modify the selection before proceeding. After confirmation, the system performs a DOM snapshot and bitmap fusion capture (step 506), exporting both a structural representation of the underlying document object model and a rasterized bitmap of the rendered content. These complementary data streams are fused to preserve semantic context and visual fidelity, thereby improving downstream optical character recognition and layout analysis. The captured data is then processed by applying a redaction and policy filter (step 508), which may include masking sensitive fields, excluding interface chrome, or enforcing enterprise rules such as restricting captures to authorized domains. Following filtering, the system conducts secure transmission to the server (step 510) using encryption and authenticated transport protocols. The server then performs content analysis (step 512), applying OCR, natural language processing, and contextual classification to interpret the captured region. Finally, the AI assistant engine generates a contextual response (step 514), which is rendered back within the desktop overlay to guide the user through the relevant portion of the task or workflow. Through this pipeline, desktop device 111 enables precise, privacy-preserving contextual assistance with enhanced control, multi-monitor awareness, and enterprise-grade compliance features.

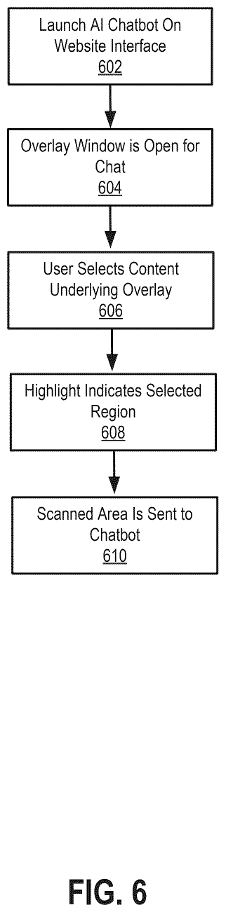

FIG. 6 illustrates an exemplary method for initiating a scan snap capture through a website-based chat interface. The process begins when the user launches an AI chatbot on a website interface (step 602). In this embodiment, the chatbot may be presented within an embedded overlay or a pop-up frame of the host website. Once launched, the overlay window is opened for chat (step 604), thereby allowing the user to view the assistant while continuing to navigate underlying webpage content.

The method then proceeds as the user selects content underlying the overlay (step 606). This selection may be performed by clicking, tapping, or dragging across the portion of the screen that contains the subject matter of interest. In response, the system surfaces a highlight to indicate the selected region (step 608), which provides visual confirmation of the exact boundaries of the capture. This highlight may be rendered as a bounding box, shading, or other graphical overlay.

After the region is highlighted and confirmed, the scanned area is sent to the chatbot (step 610). Transmission may include both a bitmap image and a structured DOM snapshot, which can be analyzed by the AI assistant engine 112 and content analysis module 124 as described in FIG. 1. The chatbot then incorporates the scanned content into the conversation, enabling contextual responses without requiring the user to manually describe the underlying issue.

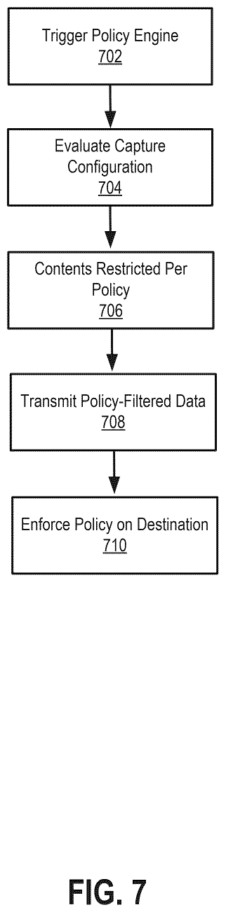

FIG. 7 illustrates an exemplary method for enforcing enterprise policy controls during overlay-based content capture. The process begins when a capture event triggers the policy engine (step 702). In some embodiments, this is managed by the enterprise policy controls 184 on the client device and/or the policy, telemetry, and audit module 138 on the server. The policy engine ensures that all subsequent actions are governed by organizational rules and compliance requirements.

The system then evaluates the capture configuration (step 704), which may include factors such as the source domain, the type of application window, the scope of the capture region, and any metadata associated with the session. During this stage, the policy engine compares the requested capture against pre-defined enterprise rules, such as prohibiting full-screen captures, restricting captures to approved domains, or automatically excluding browser chrome and sensitive UI elements.

Based on this evaluation, the system restricts contents per policy (step 706). Restriction may include redaction of personally identifiable information, masking of account numbers or financial data, removal of protected health information, or complete blocking of the capture when policy thresholds are not met. These actions ensure that only authorized information is processed further.

Once filtering has been applied, the system proceeds to transmit policy-filtered data (step 708). At this stage, only compliant content is encrypted and sent through the transport/security module 130 to the server 102 for analysis. Data that has been masked or restricted never leaves the client device, reducing the risk of inadvertent disclosure.

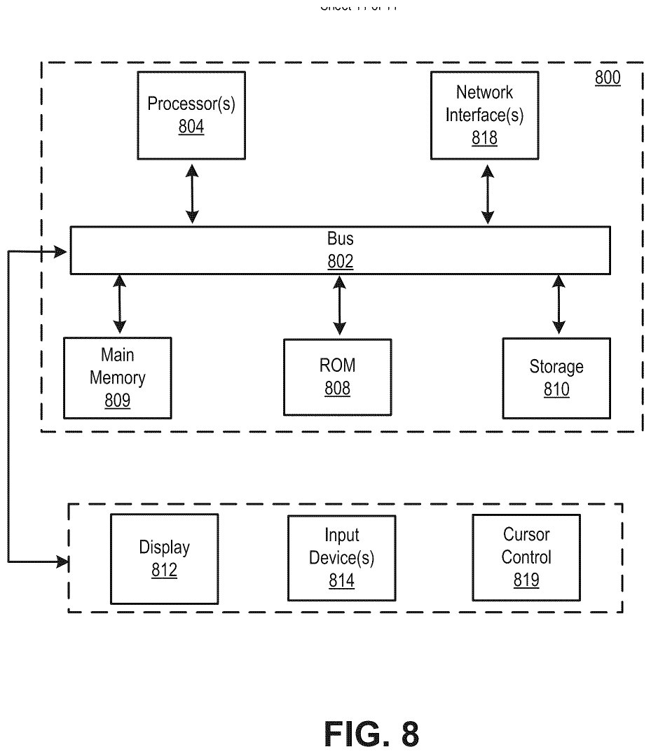

Finally, the system enforces policy on the destination (step 710). This may include recording audit entries in the policy, telemetry, and audit module 138, tagging the data with retention and classification labels, and restricting downstream use of the captured content to authorized workflows. By enforcing policy both at the client capture stage and again at the destination, the system ensures end-to-end compliance and provides auditable assurance for regulated industries.

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 8. Various embodiments are described in terms of this example computing module 800. After reading this description, it will become apparent to a person skilled in the relevant art how to implement the technology using other logical circuits or architectures.

FIG. 8 illustrates an example computing module 800, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAS, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIGS. 1A-1C. Various embodiments are described in terms of this example-computing module 800. After reading this description, it will become apparent to a person skilled in the relevant art how to implement the application using other computing modules or architectures.

Referring now to FIG. 8, computing module 800 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 800 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 800 might include, for example, one or more processors, controllers, control modules, or other processing devices, such as a processor 804. Processor 804 might be implemented using a general-purpose or special-purpose processing engine such as, for example, a microprocessor, controller, or other control logic. In the illustrated example, processor 804 is connected to a bus 802, although any communication medium can be used to facilitate interaction with other components of computing module 800 or to communicate externally. The bus 802 may also be connected to other components such as a display 812, input devices 814, or cursor control 816 to help facilitate interaction and communications between the processor and/or other components of the computing module 800.

Computing module 800 might also include one or more memory modules, simply referred to herein as main memory 806. For example, preferably random-access memory (RAM) or other dynamic memory might be used for storing information and instructions to be executed by processor 804. Main memory 806 might also be used for storing temporary variables or other intermediate information during execution of instructions to be executed by processor 804. Computing module 800 might likewise include a read only memory (“ROM”) 808 or other static storage device 810 coupled to bus 802 for storing static information and instructions for processor 804.

Computing module 800 might also include one or more various forms of information storage devices 810, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 810 might include other similar instrumentalities for allowing computer programs or other instructions or data to be loaded into computing module 800. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 800.

Computing module 800 might also include a communications interface or network interface(s) 818. Communications or network interface(s) interface 818 might be used to allow software and data to be transferred between computing module 800 and external devices. Examples of communications interface or network interface(s) 818 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 818 might typically be carried on signals, which can be electronic, electromagnetic (which includes optical) or other signals capable of being exchanged by a given communications interface. These signals might be provided to communications interface 818 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 806, ROM 808, and storage unit interface 810. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 800 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method providing context-aware assistance, comprising:
receiving, by an overlay interface rendered on a user device, a request to initiate assistance;
capturing, by a scan-snap capture process, content of a host application underlying the overlay interface to produce captured content;
applying, by a privacy filter, one or more redactions to the captured content to generate filtered content;
transmitting, via an encrypted channel, the filtered content to a server;
analyzing, by the server, the filtered content to determine a context associated with a user issue; and
generating and causing display, within the overlay interface, of a context-aware response based at least in part on the context.

2. The method of claim 1, wherein capturing the content comprises exporting a document object model (DOM) snapshot, acquiring a pixel-buffer screenshot, or fusing the DOM snapshot with the pixel-buffer screenshot.

3. The method of claim 1, further comprising performing, on the user device prior to the transmitting, a lightweight optical character recognition (OCR) prepass to extract candidate tokens or text bounding boxes used to accelerate the analyzing.

4. The method of claim 1, wherein the overlay interface is semi-transparent while the host application remains scrollable, and the capturing is triggered when a viewport tracker detects stability for at least a threshold interval.

5. The method of claim 1, further comprising determining, by a region-inference mechanism, bounds of content beneath the overlay interface that exclude overlay chrome and rounded-corner regions.

6. The method of claim 1, wherein the user device is a desktop device and the capturing further comprises invoking a clipping interface to define a rectangular region and presenting a live preview pane of the rectangular region before the transmitting.

7. The method of claim 1, wherein the user device is a mobile device and the request to initiate assistance is received responsive to a gesture input comprising a swipe, pull-up, or long-press.

8. The method of claim 1, further comprising enforcing enterprise policy prior to the transmitting by masking one or more sensitive fields, restricting capture to an allow-listed domain, or blocking the capture based on policy.

9. The method of claim 1, further comprising synchronizing a session context so that the context-aware response generated for a first user device is presented on a second user device participating in a same conversational session.

10. The method of claim 1, wherein the analyzing comprises invoking one or more external application programming interfaces (APIs) to obtain OCR services, knowledge-base lookups, or domain-specific data that inform the context-aware response.

11. A computer-implemented system for providing context-aware assistance, comprising:
a user device including an overlay interface configured to receive a request to initiate assistance and to display a context-aware response;
a scan-snap capture module configured to capture content of a host application underlying the overlay interface to produce captured content;
a privacy control module configured to apply one or more redactions to the captured content to produce filtered content;
a transport/security module configured to transmit the filtered content to a server via an encrypted channel; and
the server comprising a content analysis module configured to analyze the filtered content to determine a context associated with a user issue and a response generation module configured to generate the context-aware response for presentation within the overlay interface.

12. The system of claim 11, wherein the scan-snap capture module is configured to obtain at least one of: (i) a DOM snapshot, (ii) a pixel-buffer screenshot, or (iii) a fused representation combining the DOM snapshot and the pixel-buffer screenshot.

13. The system of claim 11, further comprising an on-device OCR module configured to perform a lightweight OCR prepass to extract tokens or text regions prior to transmission.

14. The system of claim 11, wherein the overlay interface is semi-transparent while the host application remains scrollable, and the system further comprises a viewport tracker configured to trigger capture upon detection of viewport stability.

15. The system of claim 11, further comprising a region-inference component configured to compute bounds of content beneath the overlay that exclude overlay chrome and non-content areas including rounded-corner regions.

16. The system of claim 11, wherein the user device is a desktop device and further comprises a clipping interface module configured to receive a user-defined capture region and to display a live preview pane of the capture region prior to transmission.

17. The system of claim 11, wherein the user device is a mobile device and the overlay interface is invocable via a gesture controller that recognizes a swipe, pull-up, or long-press gesture.

18. The system of claim 11, further comprising enterprise policy controls configured to enforce one or more organizational rules including masking of sensitive fields, restriction to allow-listed domains, or blocking of unauthorized captures, and a policy/telemetry/audit module configured to record audit events.

19. The system of claim 11, further comprising a session context module configured to synchronize captured content and responses across multiple user devices participating in a same conversational session.

20. The system of claim 11, wherein the content analysis module is further configured to invoke external APIs for OCR, knowledge-base lookups, or domain-specific data to inform the response generation module.
